(19) United States
(12) Patent Application Publication
(10) Pub. No.: US 2005/0068564 A1
(43) Pub. Date: Mar. 31, 2005

(54) Systems and methods for providing interactive printing with job data pull

(76) Inventor: Andrew R. Ferlitsch, Tigard, OR (US)

Correspondence Address: Michael F. Krieger;KIRTON & McCONKIE, Suite 1800, 60 East South Temple, Salt Lake City, UT, 84111, US

(21) Appl. No.: 10/676,988

(22) Filed: Sep. 30, 2003

(51) Int. Cl. G06F 3/12; G06F 15/167; G06F 15/00

(52) U.S. Cl. 358/1.15; 710/19; 358/1.16; 709/212

(57) ABSTRACT

Systems and methods for providing interactive printing that includes displaying and selecting print or fax jobs on a front panel of a printer device without the print job being despooled to the printer device. In an interactive printing environment, a print job is initiated without specifying a particular printing device. The print job is stored at a client computing device or at a printer server, and the job data (non-print data) corresponding to the print job is stored at the printer server. Job data is obtained at a printing device from the printer server and selectively displayed on the front panel of the printing device. Upon selection of the job data at the printing device, the corresponding print job is despooled to the printing device from the printer server or client computing device. The print job is then rendered at the printer device.

### BACKGROUND OF THE INVENTION

1. Field of the Invention

The present invention relates to rendering print or fax jobs. In particular, the present invention relates to systems and methods for providing interactive printing that includes displaying and selecting print or fax jobs on a front panel of a printer device without the print job being despooled to the printer device.

2. Background and Related Art

A variety of interactive printing techniques are currently available. For example, in one technique a print job includes a command to instruct a printing device to retain or store the print job, generally referred to as job retention. Thus, the entire print job is despooled to a printing device and retained at the printing device.

The print job may be selected for printing from the printing device. Generally, the job data (i.e., information uniquely identifying the print job and possibly job related settings) for each retained print job is displayed on a menu on the front panel. The user can scroll through the entries and select one or more of the print jobs to begin printing, which may require authentication, generally referred to as confidential print. Once printed, the print job and job data, depending on the job retention mode, is either deleted from storage or continued to be held for subsequent print/fax.

Another technique initially despools the job data only (i.e., job identification), and not the associated print job (i.e., job/page control settings and print data), to the printing device. The job data is then retained in storage on the printing device and typically includes a command to instruct the printing device to either print the job immediately, generally referred to as automatic printing, or retain the print job rather than immediately printing the print job, generally referred to as interactive printing. In the case of interactive printing, once the job data is despooled to the printing device, the print job may be selected for printing from the printing device. Generally, the job data for each retained job is displayed on a menu from the front panel (e.g., job name, size and owner). The user may scroll through the entries and select one or more of the print jobs to begin printing, and may require authentication.

Once a print job is selected, the printing device pulls the print job from the client computing device and begins printing the print job. Once printed, depending on the job retention mode, the print job and job data is either deleted from storage on the printing device and client computing device, or retained for a subsequent print/fax operation.

In another technique, a client computing device despools a print job to a job server, without specifying a printing device. The job server then despools the job data to all printers in some predetermined printer group. Once the job data is despooled to the printing devices, the print job is selected for printing from any of the printing devices. Generally, the job data for each retained job is displayed on a menu from the front panel of any of the printing devices. The user scrolls through the entries and selects one or more of the print jobs to begin printing, which may require authentication.

Once a print job is selected, the printing device pulls the print job from the job server and begins printing the print job. Once printed, the print job and job data is deleted from storage on the printing device and a request is made to the job server to delete the print job. The print job and job data is deleted from storage on the job server, which then sends a request to each printer in the predetermined printer group to delete its local entry of the job data.

Thus, while techniques currently exist that are used to interactively print, challenges still exist, including that the a particular printer group must be predetermined, that the job data must be duplicated on each printer in the printer group, that the job server must coordinate clearing duplicated job data on the other printers when the print job is printed, etc. Accordingly, it would be an improvement in the art to augment or even replace current techniques with other techniques.

### SUMMARY OF THE INVENTION

The present invention relates to rendering print or fax jobs. In particular, the present invention relates to systems and methods for providing interactive printing that includes displaying and selecting print or fax jobs on a front panel of a printer device without the print job being despooled to the printer device.

Implementation of the present invention takes place in association with an interactive printing environment. In at least one implementation, a print job is initiated at a client computing device without specifying a particular printing device. The print job is stored at the client computing device or at a printer server, and the job data (non-print data) corresponding to the print job is stored at the printer server. Job data is obtained at a printing device from the printer server and selectively displayed on the front panel of the printing device. Upon selection of the job data at the printing device, the corresponding print job is despooled to the printing device from the printer server or client computing device. The print job is then rendered at the printer device.

While the methods and processes of the present invention have proven to be particularly useful in the area of interactively rendering a print job, those skilled in the art can appreciate that the methods and processes can be used in a variety of different applications and in a variety of different system configurations to provide interactive printing that includes displaying and selecting jobs on a front panel of a printer device without the print job being despooled to the printer device. Examples of such jobs include print jobs, fax jobs, scan jobs, document management jobs and the like that are interactively rendered according to the methods and processes of the present invention.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates a representative networked configuration in accordance with an embodiment of the present invention;

FIG. 3 is a flow chart that provides representative processing in accordance with an embodiment of the present invention;

FIG. 4 is a representative embodiment illustrating interactive job rendering;

FIG. 5 is another representative embodiment illustrating interactive job rendering;

FIG. 6 is a flow chart that provides a representative embodiment relating to pulling job data and subsequently pulling job(s);

FIG. 7 is a representative embodiment illustrating interactive job data selection;

FIG. 8 is a representative embodiment illustrating despooling a print job;

FIG. 9 is another representative embodiment illustrating despooling a print job;

FIG. 10 is a representative embodiment illustrating the communication and update of a job status;

FIG. 11 is another representative embodiment illustrating the communication and update of a job status;

FIG. 12 is a representative embodiment of interactive printing in a multiple server environment; and

FIG. 13 is a representative embodiment of interactive printing in a meta server environment.

### DETAILED DESCRIPTION OF THE INVENTION

The present invention relates to rendering print or fax jobs. In particular, the present invention relates to systems and methods for providing interactive printing that includes displaying and selecting print or fax jobs on a front panel of a printer device without the print job being despooled to the printer device.

Embodiments of the present invention take place in association with an interactive printing environment. In one embodiment, a print job is initiated without specifying a particular printing device. The print job is stored at a client computing device or at a printer server, and the job data (non-print data) corresponding to the print job is stored at the printer server. Job data is obtained at a printing device from the printer server and is selectively displayed on the front panel of the printing device. Upon selection of the job data at the printing device, the corresponding print job is despooled to the printing device from the printer server or client computing device. The print job is then rendered at the printer device, as will be further discussed below.

In the disclosure and in the claims the term “print job” shall refer to any type of job that can be rendered at an imaging device, such as a printer device. Examples include fax jobs, scan jobs, document management jobs, text and/or graphics for printing, and the like.

The following disclosure of the present invention is grouped into two subheadings, namely “Exemplary Operating Environment” and “Interactive Printing with Job Data Pull.” The utilization of the subheadings is for convenience of the reader only and is not to be construed as limiting in any sense.

### Exemplary Operating Environment

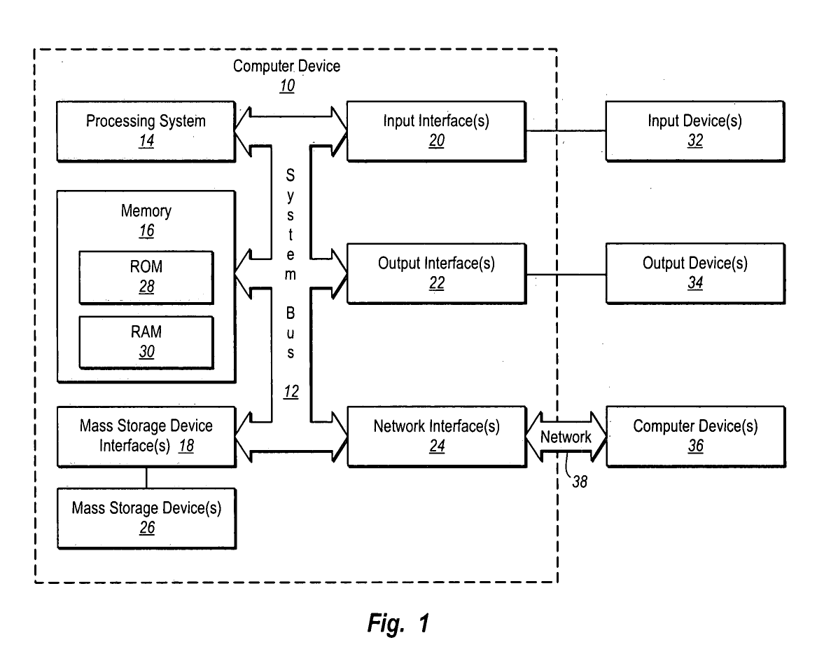

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

Those skilled in the art will appreciate that embodiments of the present invention embrace a variety of different system configurations. For example, some embodiments of the present invention embrace local printer environments, network printer environments, remote printer environments, etc. In one embodiment, the system configuration includes one or more printer devices (e.g., multifunctional peripherals “MFP” or other printer devices), one or more client computer devices, optionally a server computer device, and a network communication that enables transmitting information relating to print jobs. Other embodiments of the present invention embrace one or more computer devices locally or remotely connected to a plurality of printer devices for the rendering of print jobs.

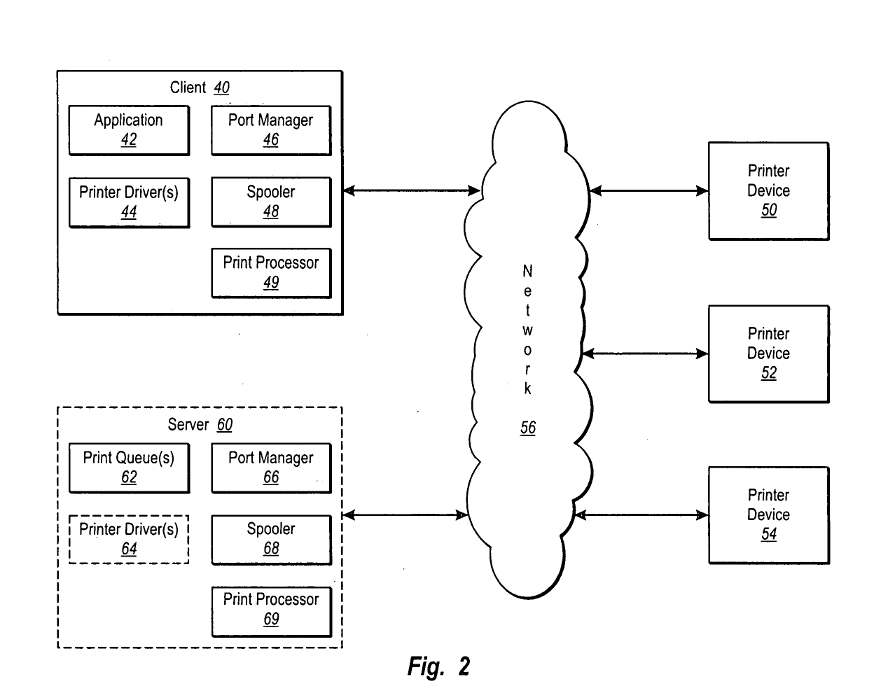

Thus, while those skilled in the art will appreciate that embodiments of the present invention may be practiced in a variety of different environments with many types of system configurations, FIG. 2 provides a representative networked configuration that may be used in association with the present invention. While FIG. 2 illustrates an embodiment that includes a client, three printer devices, and optionally a print server connected to a network, alternative embodiments include more than one client, less than three printer devices, more than three printer devices, no server, and/or more than one server connected to a network. Moreover, other embodiments of the present invention include local, networked, or peer-peer printing environments, where one or more computer devices are connected to a plurality of printing devices for rendering print jobs. Some embodiments include wireless networked environments, or where the network is a wide area network, such as the Internet.

The representative system of FIG. 2 includes a computer device, illustrated as client 40, which is connected to a plurality of peripheral devices (illustrated as printer device 50, printer device 52, and printer device 54) across network 56. In FIG. 2, printer devices 50-54 may be any type of printing device that may be used to render a print job. In one embodiment, the capabilities of a printer device are heterogeneous to the capabilities of the other printer devices (e.g., at least one of the capabilities of one printing device, such as printer device 50, are different from the capabilities of another printer device, such as printer device 52). In another embodiment, the capabilities of the printer devices are homogeneous.

As provided above, while printer devices 50-54 are connected to network 56, embodiments of the present invention embrace the use of peripheral devices (e.g., printer devices) that are locally connected to a computer device, that are configured in a peer-to-peer printing environment, or that are configured in a wireless network environment.

In the illustrated embodiment, client 40 includes a software application 42, one or more print drivers 44, a port manager 46, a spooler 48, and a print processor 49. A server 60 is optionally included having, for example, one or more print queues 62, one or more printer drivers 64, a port manager 66, a spooler 68, and a print processor 69.

Some embodiments include one or more compatible printers (e.g., identical PDL interpreters) connected in a local, remote or network print environment, a computing device capable of spooling a print job and optionally printer server capable of queuing and despooling a print job. The print jobs are interactively displayed and selected on a front panel of a printer device prior to the print data and job data being despooled to the printer. The computer based printing system results in improved utilization of printing devices for interactive printing with reduced network traffic.

In other embodiments, the printers have non-compatible PDL interpreters or capabilities. In such embodiments, the print server may additional modify the print job or emulate capabilities to be compatible with the printing device that selected the print job.

Thus, in accordance with the illustrated embodiment and other embodiments of the present invention, print jobs are interactively rendered in a printer device environment, as will be further discussed below.

### Interactive Printing With Job Data Pull

As provided above, the present invention relates to rendering print or fax jobs. In particular, the present invention relates to systems and methods for providing interactive printing that includes displaying and selecting print or fax jobs on a front panel of a printer device without the print job being despooled to the printer device.

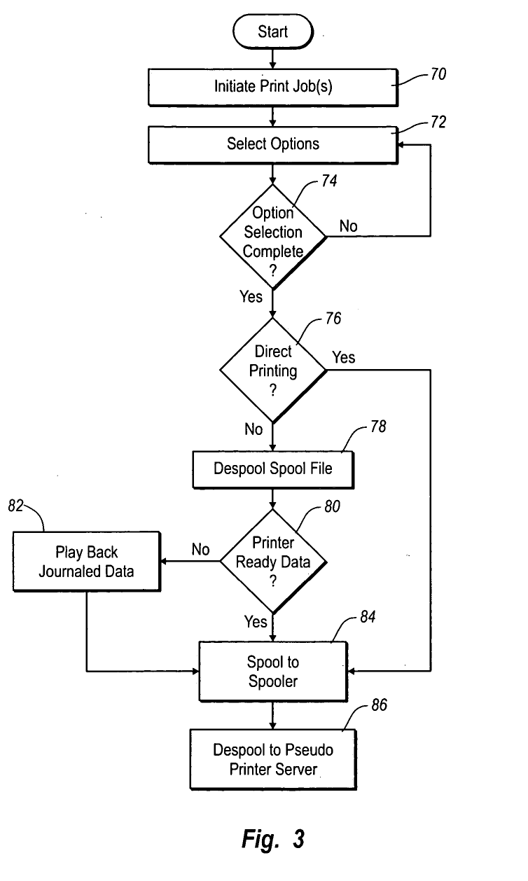

With reference now to FIG. 3, a flow chart is illustrated that provides representative processing in accordance with an embodiment of the present invention. In FIG. 3, a user initiates one or more print jobs at step 70, wherein each print job includes one or more documents having one or more pages, and wherein each print job may include instructions to render one or more copies thereof.

Upon initiation of a print job at step 70 the user issues a command or other stimulus that the user intends to spool a print job. The print subsystem responds to the user by presenting the user a dialog or other interface in which the user can select options at step 72 relating to the spooling of the print job. One of the options is the selection of to which printing device the print job will be despooled for rendering. Further to step 72, a print subsystem may responds by loading the printer driver and other components associated with the printing device, and the printer driver responds to the user by presenting the user a dialog, or other interface, in which the user may select options relating to the printing device's capabilities (e.g., print quality, paper size, orientation, tray selection, manual feed, duplex, collation, stapling, hole punching, watermarks, etc.)

At decision block 74 a determination is made as to whether or not the selection of options is complete. If it is determined that the selection of options is not complete, execution returns to step 72.

Once the selection of options is complete, a determination is made at decision block 76 as to whether or not a direct printing process is to be employed. In direct printing processes, the user spools print jobs without preprocessing the document and/or image data through a printer driver. In these processes or systems, the print data remains in the native document and/or image format, and the printing device is assumed to have the capability of interpreting/processing the respective formats. Accordingly, if it is determined that direct printing is to be employed, execution proceeds directly to step 84. Alternatively, if it is determined that direct printing is not to be employed, execution proceeds to step 78.

At step 78, once a spool file is completed, the spooler despools (immediately or on a delayed basis) the spool file directly to the selected printing device(s), or to an associated printer queue on a printer server. In the case of a printer server, the printer server despools the print job (immediately or on a delayed basis) directly to the selected printing device(s).

In at least one embodiment, the user does not select a specific printing device(s).

Instead, the user selects a pseudo printer server, where the pseudo printer server is not associated with any specific printing device. The pseudo printer server is installed as a local or network printer and has a corresponding printer driver, where the corresponding printer driver has the capabilities to generate a print job for some logical grouping of printing devices.

The user may install multiple pseudo printer servers with different printer drivers for different logical groupings of printing devices. For example, the user may install one pseudo printer server with a printer driver for PCL printers and another for Postscript printers. Alternatively, the user may install one pseudo printer server for printers with stapler finishers and another without stapling capabilities.

The printer driver associated with the selected pseudo printer server processes the print job into printer ready data. Accordingly, at decision block 80 a determination is made as to whether or not the data is printer ready data. If it is determined that it is printer ready data, execution proceeds to step 84, where the print job is spooled to the spooler. The spooler then (immediately or on a delayed basis) despools the print job to the pseudo printer server at step 86.

Alternatively, if it is determined at decision block 80 that the data is not printer ready data, the print job may be journaled and processed later into printer ready data by the pseudo printer server. This is illustrated at step 82, where the data is played back and then spooled to the spooler at step 84 and then to the pseudo printer server at step 86.

As provided above, in direct printing, where there is no processing by a printer driver, the document or image data is spooled to the spooler, as illustrated as step 84. The spooler then (immediately or on a delayed basis) despools the document or image data to the pseudo printer server at step 86, which stores the print job.

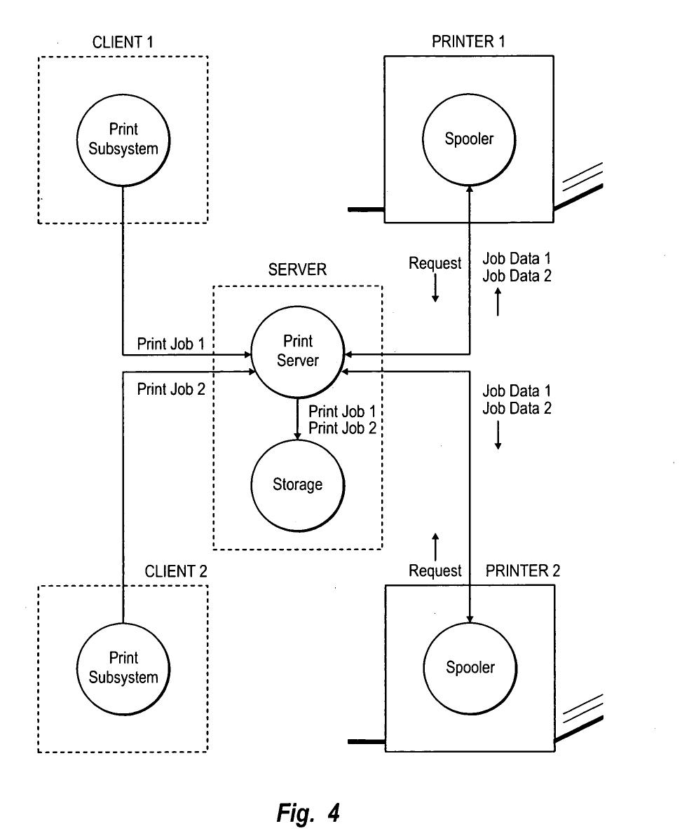

In FIG. 4, a representative embodiment illustrating interactive job rendering is provided as a block diagram, wherein the system includes multiple clients, a server and multiple printer devices for the interactive rendering of print jobs.

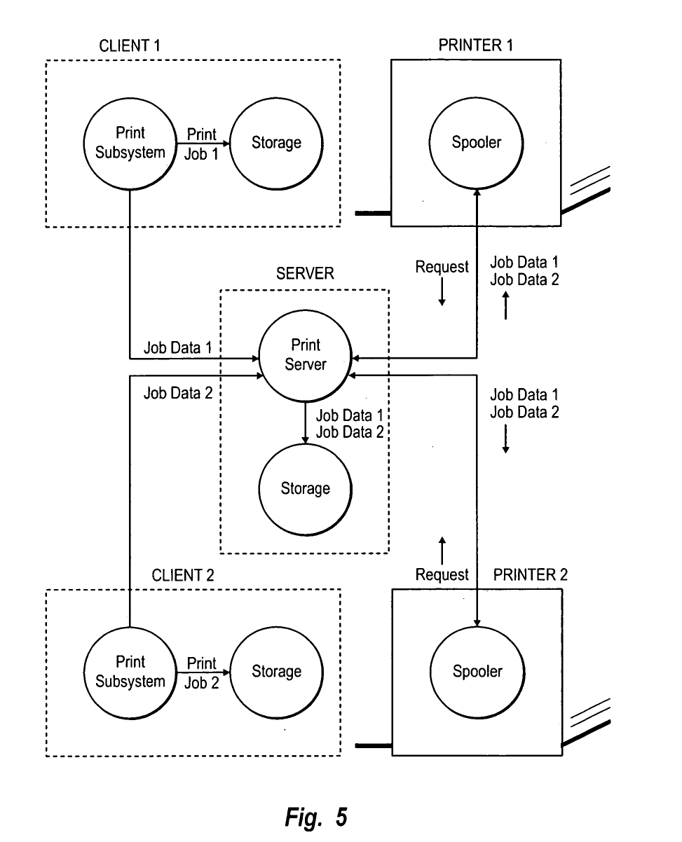

In at least some embodiments, a component of the print subsystem (e.g., a spooler or other component) despools only the job data and not the print data to the pseudo printer server. The job data is enough information to uniquely identify and locate the print job. By way of example, the job information may include (i) the job name; (ii) the job identification; (iii) the client name; and (iv) the user name. The job data may also include other information about the print job which may be useful to know at the front panel. Examples include information relating to paper stock requirements, finishing mode requirements, authentication controls, etc. An example of such an embodiment is illustrated in FIG. 5.

In accordance with at least some embodiments of the present invention, and as illustrated in FIGS. 4 and 5, the print job and job data reside on the client computing device and/or the pseudo printer server until the user interactively initiates the despooling and printing of the print job to the printing device. The user may select any printing device that can access and communicate with the pseudo printer server as the printing device to print a print job.

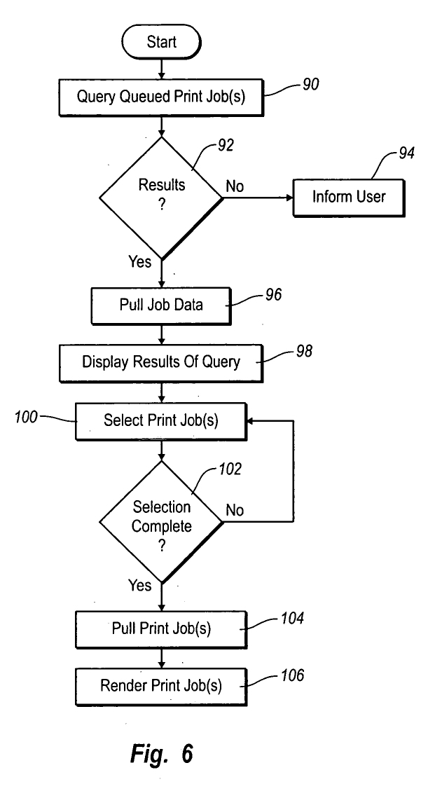

FIG. 6 provides a flow chart that illustrates a representative embodiment relating to pulling job data and subsequently pulling the corresponding print job(s). Initially, the user initiates a process on the printing device at step 90 to query the pseudo printer server on queued print jobs. The job data is then pulled from the pseudo printer server to the printing device, where it can then be displayed and selected. Typically, the user initiates this process, display and selects a print job from the front panel of a printing device. The user may also perform these processes by other means such as by a remote interface.

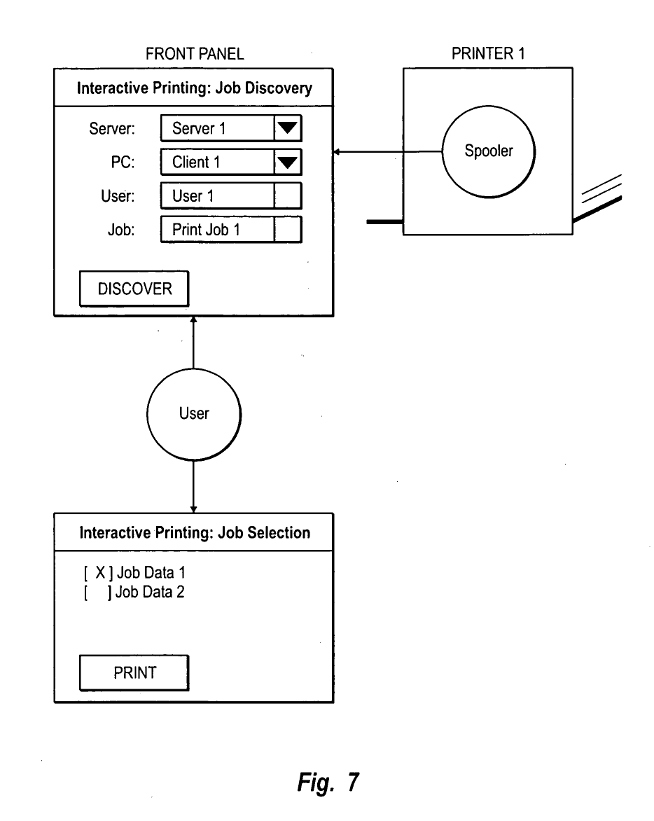

Thus, the user may query the pseudo printer server for available print jobs by a variety of criteria, including based on (i) jobs on a specific pseudo printer server; (ii) jobs from a specific client computing device; (iii) jobs initiated from a specific user; (iv) a specific print job; and/or (v) a specific printing characteristic (e.g., all jobs requiring stapling). Based on the criteria, the printer server then sends back to the printing device job data on all print jobs that meet the criteria, where the job data can then be displayed and selected on the printing device. FIG. 7 is a representative embodiment illustrating interactive job data selection.

Thus, with reference back to FIG. 6, once the queued print jobs have been queried at step 90, a determination is made at step 92 as to whether or not any results were received as a result of the query. If no results were obtained, execution proceeds to step 94, where the user is notified that no results were obtained. Alternatively, if results are obtained, the job data is pulled at step 96 and the results are displayed at step 98. At step 100, the user selects one or more of the print jobs corresponding to the job data.

At decision block 102, a determination is made as to whether or not the user has completed the selection. If it is determined that the user has not completed the selection, execution returns back to step 100. Once the selection has been completed from among the job data, the respective print jobs are then pulled by the printing device from the pseudo printer server and/or the client computing device at step 104.

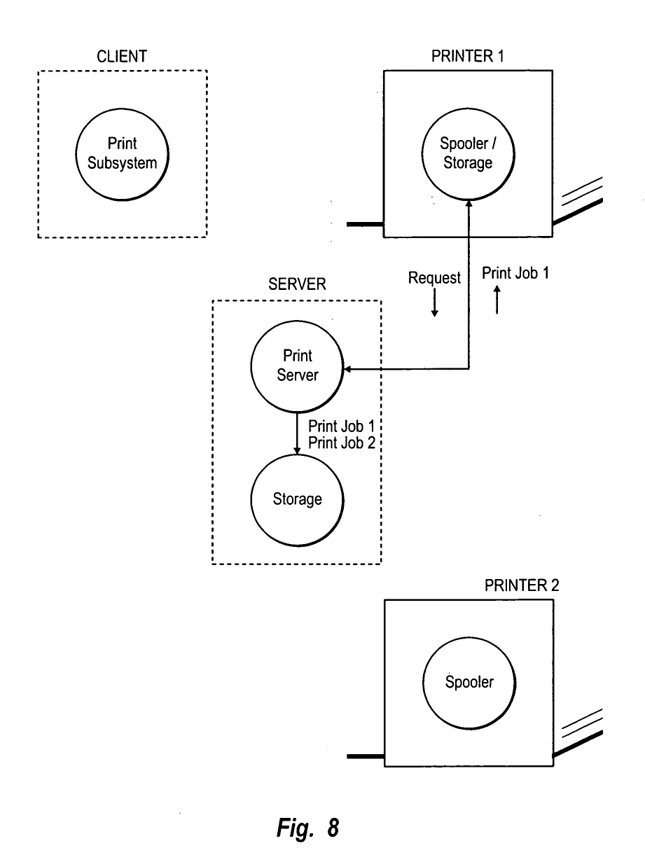

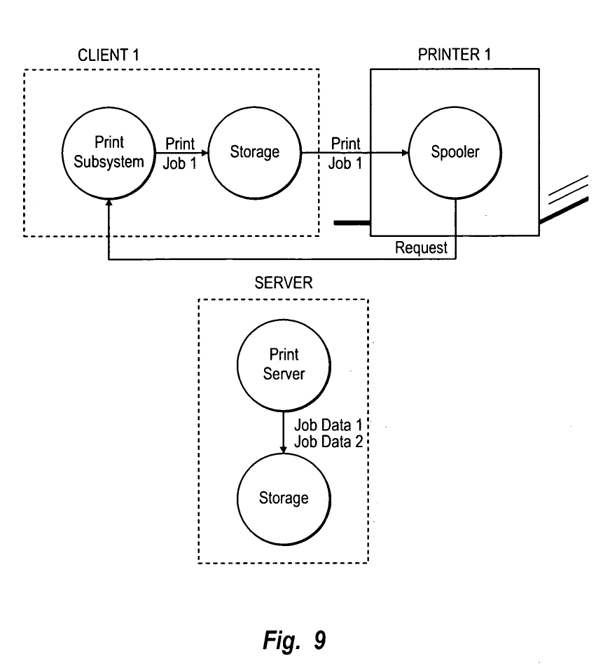

FIG. 8 illustrates a representative embodiment for despooling the print job(s) from the pseudo printer server. FIG. 9 illustrates a representative embodiment for despooling the print job(s) from the client computing device.

After the print job is despooled to the printing device at step 104, the printing device prints the print job at step 106. The rendering of the print job(s) may be performed immediately. Alternatively, the print jobs may continue to be retained on the printing device and printed at some other point in time, such as a time scheduled job or event.

In some embodiments, the print job(s) stored on the pseudo print server are not in printer ready format. Instead, the print jobs are stored in a journaled format (e.g., EMF on Microsoft® Windows), or other printer independent format (e.g., PDF). When despooling of the print job is initiated, the pseudo print server first converts the journaled or otherwise printer independent format into a printer dependent format specific to the printing device that selected the print job (e.g., playing back the EMF data to a printer driver associated with the selected printer).

In some embodiments, the print job(s) stored on the pseudo print server are in printer ready format which is not compatible with the printing device. When despooling of the print job is initiated, the pseudo print server first converts the non-compatible printer dependent format into a compatible printer dependent format (e.g., PCL to Postscript, input/output tray mappings). In other embodiments, where the printing device lacks a capability required by the print job, the pseudo print server emulates, where possible, the capability on the host side (e.g., copy collation, booklet printing, N-up printing).

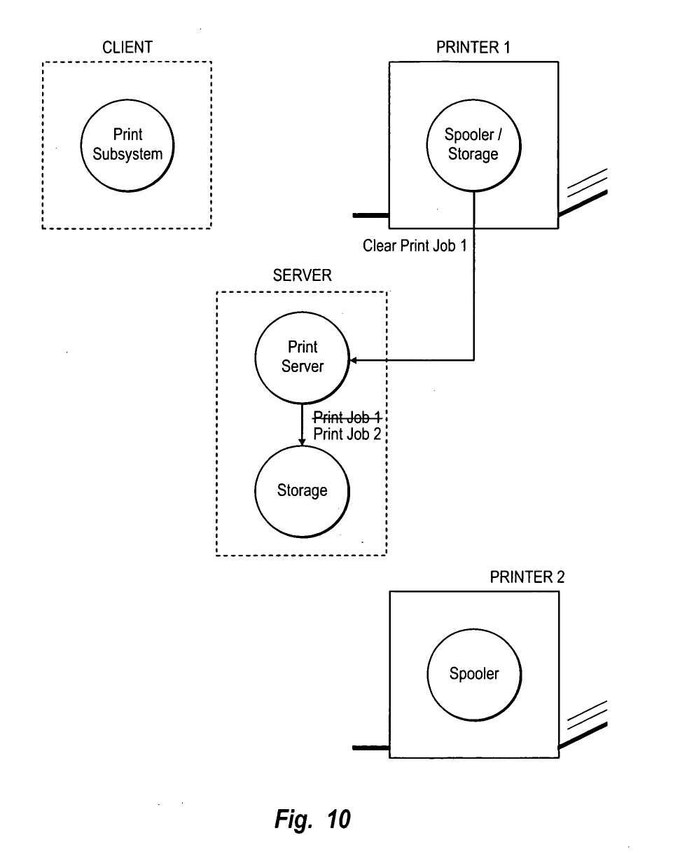

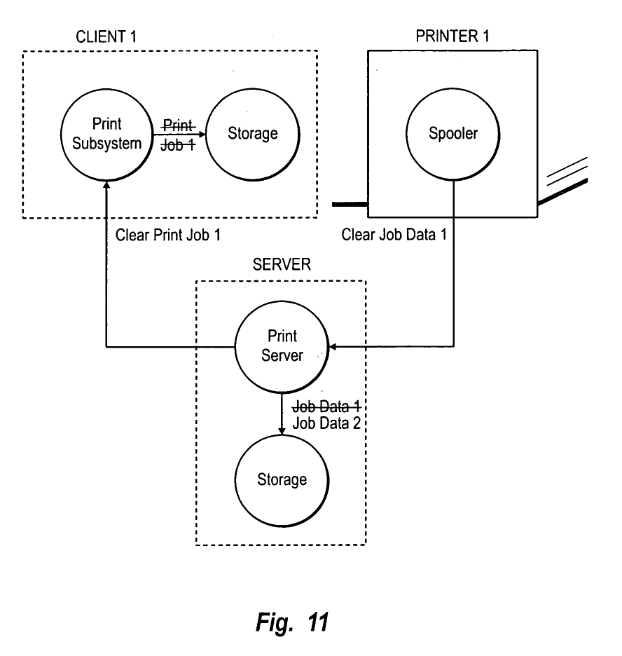

In at least some embodiments, the job status between devices is updated. Thus, for example, the printing device communicates status information to the pseudo printer server. Such status information may include: (i) that the print job was successfully despooled to the printing device—the print job is marked as printing and the print job and job data continue to be retained on the pseudo printer server and/or on the client computing device; and/or (iii) that the print job was successfully printed on the printing device—the print job is marked as printed and the print job and job data are deleted from the pseudo printer server and/or the client computing device. Representative embodiments illustrating the communication and update of a job status are illustrated in FIGS. 10 and 11.

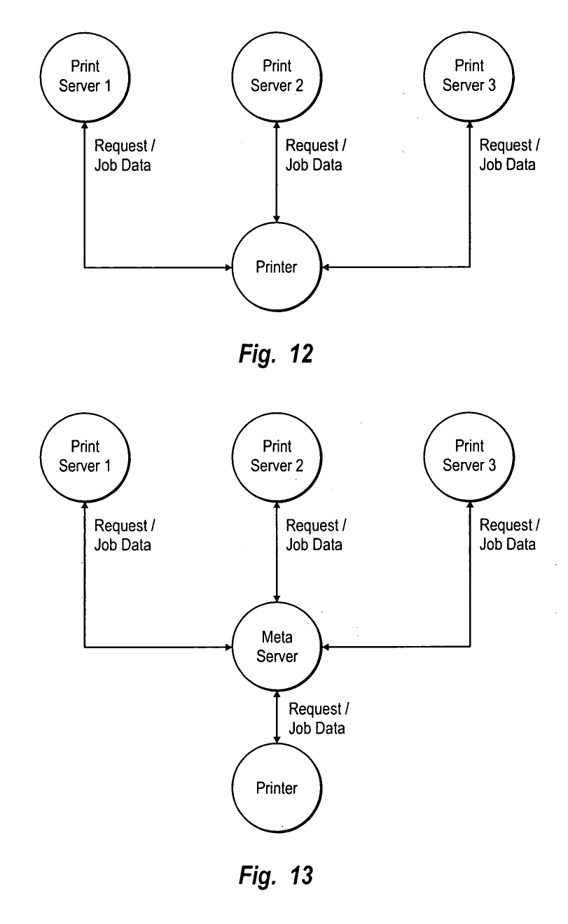

In accordance with some embodiments of the present invention, a user initiates the job data fetch from multiple pseudo printer servers. The pseudo printer servers are predetermined by the printing device, pre-specified by the user, or dynamically discovered by a discovery process. FIG. 12 is a representative embodiment of interactive printing in a multiple server environment.

In other embodiments, the job data fetch is made from a meta printer server, where the meta printer server is an interface between the printing device and one or more pseudo printer servers. FIG. 13 is a representative embodiment of interactive printing in a meta server environment. In the embodiment illustrated in FIG. 13, the pseudo printer servers are determined at the meta printer server and not at the printing device.

While embodiments of the present invention embrace spooling and despooling subsystems of a Microsoft® Windows operating system, other embodiments embrace the spooling and despooling subsystems of an Apple® MacIntosh operating system, a Linux® operating system, a System V Unix® operating system, a BSD Unix® operating system, an OSF Unix® operating system, a Sun® Solaris operating system, an HP/UX operating system, an IBM® Mainframe MVS and AS/400 operating system, and the like.

Thus, as discussed herein, the embodiments of the present invention embrace rendering print or fax jobs. In particular, the present invention relates to systems and methods for providing interactive printing that includes displaying and selecting print or fax jobs on a front panel of a printer device without the print job being despooled to the printer device. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. In a printing system, a method for displaying print job information for selection on a front panel of a printer prior to despooling the print jobs to the printer, the method comprising:
initiating a print job;
preserving the print job on at least one of (i) a client computer device and (ii) a print server;
storing job data on the print server, wherein the job data is associated with the print job;
transmitting the job data from the print server to a printing device;
displaying at least a portion of the job data prior to despooling the print job to the printing device;
despooling the print job to the printing device; and
rendering the print job at the printing device.

2. A method as recited in claim 1, wherein the step for initiating the print job is performed at the client computer device, and wherein the print job is initiated without specifying the printing device.

3. A method as recited in claim 1, wherein the step for transmitting the job data from the print server to the printing device comprises:
querying queued print jobs; and
pulling the job data from the print server to the printing device as a result of the query performed.

4. A method as recited in claim 3, further comprising receiving input that selects the job data and initiates the steps for despooling and rendering the print job.

5. A method as recited in claim 3, wherein the step for querying is based on at least one of:
(i) jobs on a specific printer server;
(ii) jobs from a specific client computer device;
(iii) jobs initiated from a specific user;
(iv) a specific print job; and
(v) a specific printing characteristic.

6. A method as recited in claim 1, wherein the printer server is not associated with any particular printing device.

7. A method as recited in claim 1, wherein the job data uniquely identifies and locates the print job, and wherein the job data includes at least one of:
(i) a job name;
(ii) a job identification;
(iii) a client name; and
(iv) a user name.

8. A method as recited in claim 1, wherein the step for displaying at least a portion of the job data comprises one of:
displaying the at least a portion of the job data on a front panel of the printing device for selection by a user; and
remotely displaying the at least a portion of the job data on an interface for selection by a user.

9. A method as recited in claim 1, further comprising at least one of:
updating a current status of the print job at the client computer device; and
updating the current status of the print job at the print server.

10. A method as recited in claim 1, wherein the step for transmitting the job data from the print server to the printing device comprises:
querying multiple print servers for queued print jobs; and
pulling the job data from one of the multiple print servers to the printing device as a result of the query performed.

11. A method as recited in claim 1, wherein the step for transmitting the job data from the print server to the printing device comprises:
querying multiple print servers for queued print jobs, wherein the multiple print servers are queried from a meta print server;
pulling the job data from one of the multiple print servers to the meta print server as a result of the query performed; and
transmitting the job data from the meta printer server to the printing device.

12. A method as recited in claim 1, further comprising transmitting updated status information from the printing device to at least one of (i) the print server and (ii) the client computer device.

13. A method as recited in claim 12, wherein the step for transmitting updated status information updates at least one of:
(i) a status of the print job; and
(ii) a status of the job data.

14. A method as recited in claim 12, wherein the updated status information includes at least one of:
(i) information indicating that the print job has been despooled to the printing device; and
(ii) information that the print job has been rendered at the printing device.

15. A method as recited in claim 12, further comprising at least one of:
deleting the print job at the client computing device;
deleting the print job at the printer server; and
deleting the job data at the printer server.

16. A method as recited in claim 1, further comprising:
if the print job is in a journaled format, converting the journaled print job into a printer ready format, wherein the converting occurs after the step for displaying at least a portion of the job data and before the step for despooling the print job to the printing device.

17. A method as recited in claim 1, further comprising:
if the print job is in a non-compatible format with the printing device, converting the print job into a format that is compatible with the printing device.

18. A method as recited in claim 1, further comprising:
if the print job includes one or more capabilities that are incompatible with the printing device, emulating the capabilities to be compatible with the printing device.

19. A method as recited in claim 18, wherein the capabilities relate to at least one of:
(i) copy collation;
(ii) booklet printing; and
(iii) N-up printing.

20. An interactive printing system comprising:
a print job initiated at a client computing device and preserved at one of (i) the client computing device and (ii) a printer server;
job data corresponding to the print job, wherein the job data is preserved at the printer server;
a network coupling the client computing device, the printer server and a printing device; and
a display panel of the printing device that selectively displays at least a portion of the job data as a result of a queued print jobs query and prior to the print job being despooled to the printing device for rendering the print job.

21. An interactive printing system as recited in claim 20, wherein printing device is configured to selectively initiate the queued print jobs query based on user input received.

22. An interactive printing system as recited in claim 20, further comprising additional printer servers coupled to the network, and wherein the queued print job query is performed on the printer server and at least some of the additional printer servers.

23. An interactive printing system as recited in claim 20, further comprising a meta printer server, wherein the meta printer server is communicatively coupled to the print server and one or more additional printer servers, wherein the meta printer server is configured to perform the queued print jobs query on the print server and the one or more additional printer servers.

24. A computer program product for implementing within a computer system a method for providing interactive printing, the computer program product comprising:
a computer readable medium for providing computer program code means utilized to implement the method, wherein the computer program code means is comprised of executable code for implementing the steps for:
receiving input to initiate a print job;
preserving the print job on at least one of (i) a client computer device and (ii) a print server;
storing job data on the print server, wherein the job data is associated with the print job;
transmitting the job data from the print server to a printing device;
displaying at least a portion of the job data prior to despooling the print job to the printing device;
despooling the print job to the printing device; and
rendering the print job at the printing device.

25. A computer program product as recited in claim 24, wherein the step for receiving input to initiate the print job is performed at the client computer device, and wherein the print job is initiated without specifying the printing device.

26. A computer program product as recited in claim 24, wherein the step for transmitting the job data from the print server to the printing device comprises:
querying queued print jobs; and
pulling the job data from the print server to the printing device as a result of the query performed.

27. A computer program product as recited in claim 26, further comprising receiving input that selects the job data and initiates the steps for despooling and rendering the print job.

28. A computer program product as recited in claim 24, wherein the step for displaying at least a portion of the job data comprises one of:
displaying the at least a portion of the job data on a front panel of the printing device for selection by a user; and
remotely displaying the at least a portion of the job data on an interface for selection by a user.

29. A computer program product as recited in claim 24, wherein the step for transmitting the job data from the print server to the printing device comprises:
querying multiple print servers for queued print jobs; and
pulling the job data from at least one of the multiple print servers to the printing device as a result of the query performed.

30. A computer program product as recited in claim 24, wherein the step for transmitting the job data from the print server to the printing device comprises:
querying multiple print servers for queued print jobs, wherein the multiple print servers are queried from a meta print server;
pulling the job data from at least one of the multiple print servers to the meta print server as a result of the query performed; and
transmitting the job data from the meta printer server to the printing device.

31. A computer program product as recited in claim 24, wherein the computer 110 program code is further comprised of executable code for implementing a step for transmitting updated status information from the printing device to at least one of (i) the print server and (ii) the client computer device.

32. A computer program product as computer program product in claim 31, wherein the step for transmitting updated status information updates at least one of:
(i) a status of the print job; and
(ii) a status of the job data.

33. A computer program product as recited in claim 31, wherein the updated status information includes at least one of:
(i) information indicating that the print job has been despooled to the printing device; and
(ii) information that the print job has been rendered at the printing device.

34. A computer program product as recited in claim 31, wherein the computer program code means is further comprised of executable code for implementing at least one of:
deleting the print job at the client computing device;
deleting the print job at the printer server; and
deleting the job data at the printer server.

35. A computer program product as recited in claim 24, wherein the computer program code means is further comprised of executable code for implementing at least one of:
if the print job is in a non-compatible format with the printing device, converting the print job into a format that is compatible with the printing device; and
if the print job includes one or more capabilities that are incompatible with the printing device, emulating the capabilities to be compatible with the printing device.
